(19) United States
(12) Patent Application Publication
(10) Pub. No.: US 2026/0259380 A1
(43) Pub. Date: Sep. 3, 2026

(54) FIBER OPTIC CONNECTOR ASSEMBLY AND FABRICATION METHOD INCORPORATING MULTI-FIBER FERRULE AND THERMOPLASTIC ADHESIVE

(71) Applicant: CORNING RESEARCH & DEVELOPMENT CORPORATION, CORNING, NY (US)

(72) Inventors: Xiaole Cheng, Painted Post, NY (US); Jeffrey Dean Danley, Hickory, NC (US); Darrin Max Miller, Hickory, NC (US); Dennis Craig Morrison, Lincolnton, NC (US); Stephan Toepper, Hickory, NC (US)

(21) Appl. No.: 19/657,282

(22) Filed: Apr. 24, 2026

Related U.S. Application Data
(63) Continuation of application No. PCT/US2024/050336, filed on Oct. 8, 2024.
(60) Provisional application No. 63/546,631, filed on Oct. 31, 2023.

(51) Int. Cl. G02B 6/38; G02B 6/245

(52) U.S. Cl. CPC G02B 6/3861; G02B 6/245; G02B 6/3826; G02B 6/3839; G02B 6/3854; G02B 6/3883

(57) ABSTRACT

A fiber optic connector assembly and related fabrication methods utilize thermoplastic adhesive material arranged between stripped regions of optical fibers and micro-passages of a ferrule body, with the thermoplastic material being configured to retain a plurality of optical fibers. A fabrication method includes providing a thermal gradient between front and rear end faces of the ferrule body, causing stripped portions of optical fibers to extend through molten thermoplastic adhesive arranged between the fibers and ferrule micro-passages, and allowing the thermoplastic adhesive to solidify. This thermal gradient permits the thermoplastic material to achieve a sufficiently high temperature without compromising dimensional integrity of the front end face.

### PRIORITY APPLICATION

This application is a continuation of PCT Patent Application No. PCT/US2024/050336, filed on Oct. 8, 2024, which claims the benefit of priority of U.S. Provisional Patent Application No. 63/546,631, filed on Oct. 31, 2023, the contents of which are relied upon and incorporated herein by reference in its entirety.

### BACKGROUND

This disclosure relates generally to optical fibers, and more particularly to fiber optic connector assemblies incorporating multi-fiber ferrules, and methods for fabricating fiber optic connector assemblies.

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors (“connectors”) are often provided on the ends of fiber optic cables. The process of terminating individual optical fibers from a fiber optic cable is referred to as “connectorization.” Connectorization can be performed in a factory (resulting in a “pre-connectorized” or “pre-terminated” fiber optic cable) or in the field (e.g., using a “field-installable” connector).

Many different types of fiber optic connectors exist. In environments that require high density interconnects and/or high bandwidth, such as data centers, multi-fiber optical connectors are the most widely used. Multi-fiber optical connectors are suitable for use with multi-fiber cables and frequently utilize multi-fiber ferrules. One example of a multi-fiber optical connector is the multi-fiber push on (MPO) connector, which incorporates a mechanical transfer (MT) ferrule and is standardized according to TIA-604-5 and IEC 61754-7. These connectors can achieve a high density of optical fibers, which reduces the amount of hardware, space, and effort required to establish a large number of interconnects. Other examples of multi-fiber optical connectors are MMC connectors commercially available from US Conec Ltd. and SN-MT connectors commercially available from Senko Advanced Components, Inc. MMC connectors use a ferrule referred to as a “TMT ferrule,” which has the same fiber pitch as a MT ferrule but in a smaller form factor (i.e., half the height and half the width compared to a MT ferrule). SN-MT connectors use a multi-fiber ferrule (“SN-MT ferrule”) with a reduced guide pin bore diameter and guide pin bore pitch compared to a traditional MT ferrule, and also has a smaller form factor. Both MMC connectors and SN-MT connectors are sometimes referred to as very small form factor (VSFF) connectors.

Multi-fiber ferrules typically comprise glass-reinforced polymeric materials and are fabricated by molding. For MT, TMT, and SN-MT ferrules, fiber alignment depends on pitch and eccentricity of fiber micro-holes and alignment pin holes, with alignment being dictated by the alignment pins during mating. Critical elements for fiber alignment include the ability to hold extremely tight dimensional tolerances during the ferrule molding process, and properties (e.g., shape, tolerances, and material composition) of the alignment pins.

Despite the widespread use of MPO connectors and growing adoption of VSFF connectors in data center environments, there are still challenges to address in fabricating these connectors. Termination of multi-fiber ferrules is a time-consuming, multi-step process. One of the bottlenecks in terminating multi-fiber ferrules includes bonding of optical fibers inserted therein utilizing heat-curable two-part epoxy resins as a bonding agent. Epoxy resins, which are also known as polyepoxides, are a class of reactive prepolymers and polymers that contain one or more epoxide groups. In a typical epoxy-based termination process, epoxy material is either injected or drawn (e.g., by suction) through ferrule micro-passages in which optical fibers are inserted or present, and the ferrule with installed optical fibers and uncured epoxy are placed into a curing oven for thermal curing (e.g., for 20 minutes at 100° C., or another suitable time and temperature). The extended time and temperature range lends itself to batch processing (i.e., curing many epoxy- and fiber-loaded ferrules at once), which leads to production bottlenecks in view of subsequent processing steps (e.g., polishing) performed on individual ferrules. Shorter epoxy curing periods at higher temperatures are generally not feasible, since ferrules should not be exposed to temperatures significantly higher than 100° C. (e.g., not exceeding 125° C.-150° C. at the very highest) to avoid loss of dimensional integrity that could inhibit proper fiber alignment during connector mating.

A technical standard known as GR-1435-CORE (also known simply as “GR-1435”) outlines the requirements, features, performance criteria, and characteristics of single-mode multi-fiber optical connectors. GR-1435 is designed to test a connector's lifetime performance and reliability through a series of service life performance tests, which include environmental and mechanical tests. These tests (which are typically performed by a third party test laboratory on a set of 15 samples provided by the product manufacturer) are designed to simulate stressors that a connector may experience during its lifetime from manufacturing, storage, transport, operation, handling, and aging. GR-1435 testing includes uncontrolled environment tests, controlled environment tests, and mechanical tests. As part of the rigorous GR-1435 testing regime, fiber-terminated connectors are subjected to multiple thermal cycles (e.g., numerous cycles from −10° C. to 60° C.) while under mechanical load. Comparatively few adhesive materials other than epoxies are capable of bonding optical fibers to multi-fiber ferrules and reliably passing GR-1435 certification tests.

The art continues to seek improved fiber optic connector assemblies and fabrication methods to reduce the time required for terminating and bonding optical fibers in multi-fiber ferrules to increase throughput and reduce fabrication costs, without degrading ferrule dimensional integrity or degrading mechanical retention of optical fibers.

### SUMMARY

Aspects of the present disclosure provide a fiber optic connector assembly and related fabrication methods that utilize thermoplastic adhesive material arranged between stripped regions of optical fibers and micro-passages of a ferrule body, with the thermoplastic material configured to retain a plurality of optical fibers within the ferrule body. The thermoplastic adhesive material may have a Young's Modulus value of at least 100 MPa, a yield stress of at least 5 MPa, and a Shore A hardness of at least 80 at 25° C. The ferrule body may comprise a different degree of crystallinity at a first (e.g., front) end face than at an opposing second (e.g., rear) end face, such as may result from application of a thermal gradient between the front end face and the rear end face, with the front end face (where the plurality of optical fibers are terminated) subjected to a lower temperature than the rear end face. Higher temperature conditions experienced at the rear end face may confer a greater change in spacing between arrayed micro-passages at the rear end face than at the front end face, such that outermost micro-passages of the array are spaced apart by a first distance at the front end face, and are spaced apart by a smaller second distance at the rear end face. Preservation of spacing of micro-passages (i.e., dimensional integrity) at the front end face is beneficial to promote alignment of optical fibers during connector mating. A method for fabricating a fiber optic connector assembly comprises providing a thermal gradient between the front end face and the rear end face of the ferrule body, causing stripped portions of optical fibers to extend through molten thermoplastic adhesive arranged between the stripped portions and a plurality of micro-passages of the ferrule body, and allowing the thermoplastic adhesive material to solidify in the micro-passages between the stripped regions of the optical fibers and the ferrule body.

In exemplary aspects, a fiber optic connector assembly includes ferrule body comprising a polymer material, the ferrule body having a front end face, a rear end face, and a plurality of micro-passages defined in the ferrule body and extending through the front end face. The fiber optic connector assembly further comprises a plurality of optical fibers extending through the ferrule body and terminated at the front end face, wherein each optical fiber of the plurality of optical fibers comprises a stripped region, and the stripped region of each optical fiber extends through a corresponding micro-passage of the plurality of micro-passages. The fiber optic connector assembly further comprises a thermoplastic adhesive material arranged in the plurality of micro-passages between stripped regions of the plurality of optical fibers and the ferrule body, and configured to retain the plurality of optical fibers within the ferrule body, wherein the thermoplastic adhesive material has a Young's Modulus value of at least 100 MPa, a yield stress of at least 5 MPa, and a Shore A hardness of at least 80 at 25° C.

In other exemplary aspects, a fiber optic connector assembly includes a ferrule body comprising a polymer material, the ferrule body having a front end face, a rear end face, and a plurality of micro-passages defined in the ferrule body and extending through the front end face. The fiber optic connector assembly further includes a plurality of optical fibers extending through the ferrule body and terminated at the front end face, wherein each optical fiber of the plurality of optical fibers comprises a stripped region, and the stripped region of each optical fiber extends through a corresponding micro-passage of the plurality of micro-passages. The fiber optic connector assembly further includes a thermoplastic adhesive material arranged in the plurality of micro-passages between stripped regions of the plurality of optical fibers and the ferrule body, and configured to retain the plurality of optical fibers within the ferrule body. The ferrule body comprises at least one of the following features: (i) the ferrule body comprises a different degree of crystallinity at the first end face than at the second end face; and (ii) at least some micro-passages of the plurality of micro-passages are arranged in a one-dimensional array, with outermost micro-passages of the one-dimensional array being spaced apart by a first distance at the front end face and spaced apart by a second distance at the rear end face, with and the second distance being smaller than the first distance.

In other exemplary aspects, a method for fabricating a fiber optic connector assembly is provided, the fiber optic connector assembly including a ferrule body that comprises a polymer material and including a plurality of optical fibers each comprising a stripped region. One method step comprises heating at least a portion of the ferrule body, and providing a thermal gradient between the front end face and the rear end face of the ferrule body, with the front end face at a lower temperature than the rear end face. Another method step comprises inserting stripped portions of the plurality of optical fibers through a rear end face of the ferrule body into a plurality of micro-passages that are defined in the ferrule body and that extend through a front end face of the ferrule body, to cause the stripped portions of the plurality of optical fibers to extend at least to the front end face. Another method step comprises causing the stripped portions of the plurality of optical fibers to extend through molten thermoplastic adhesive arranged between the stripped portions of the optical fibers and the plurality of micro-passages. A further method step comprises allowing the thermoplastic adhesive to solidify in the plurality of micro-passages between the stripped regions of the optical fibers and the ferrule body.

Moreover, an exemplary fiber optic cable assembly includes a fiber optic connector assembly as disclosed herein, installed on a fiber optic cable.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of a fiber optic connector assembly and an associated fiber optic cable forming a fiber optic cable assembly, with the fiber optic connector assembly including a MT-type multi-fiber ferrule having micro-passages suitable for receiving thermoplastic adhesive material for securing optical fibers therein according to one embodiment.

FIG. 2 is an exploded perspective view of the fiber optic cable assembly of FIG. 1.

FIG. 3 is a front elevational view of the MT-type multi-fiber ferrule of FIGS. 1 and 2, showing a one-dimensional array of micro-passages extending to a front end face of the ferrule.

FIG. 4A is a front perspective view of a first TMT-type multi-fiber ferrule including a one-dimensional array of micro-passages suitable for receiving thermoplastic adhesive material for securing optical fibers therein according to one embodiment.

FIG. 4B is a perspective cross-sectional view of the TMT-type multi-fiber ferrule of FIG. 4A.

FIG. 5 is a perspective view of a fiber optic connector assembly including a TMT-type multi-fiber ferrule according to FIGS. 4A and 4B.

FIG. 6A is a perspective view of a second TMT-type multi-fiber ferrule including a two-dimensional array of micro-passages suitable for receiving thermoplastic adhesive material for securing optical fibers therein according to one embodiment.

FIG. 6B is a front elevational view of the TMT-type multi-fiber ferrule of FIG. 6A;

FIG. 7 is a perspective view of a one-dimensional array of optical fibers including stripped portions and unstripped portions thereof.

FIG. 8 is a rear perspective, partially transparent view of a TMT-type multi-fiber ferrule having first and second arrays of optical fibers terminated therein, with first and second ribbons extending from a rear central recess of the ferrule.

FIG. 9 is a front elevational view of a portion of a multi-fiber ferrule showing optical fibers retained within micro-passages of the ferrule using thermoplastic adhesive material.

FIG. 10 is a comparison plot of fiber optic ribbon pull-out strength for optical fibers retained in ferrules using three different methods: (i) addition of thermoplastic adhesive material followed by optical fiber insertion; (ii) optical fiber insertion followed by addition of thermoplastic adhesive material, and (iii) conventional epoxy bonding.

FIG. 11 is a front perspective view of a TMT-type multi-fiber ferrule subjected to a thermal gradient between a rear end face and a front end face thereof, as useful during execution of a method for fabricating a fiber optic connector assembly according to embodiments disclosed herein.

FIG. 12 is a perspective view of a first holder configured to receive a multi-fiber ferrule and permit application of a thermal gradient between a rear end face and a front end face thereof, as part of a method of fabricating a fiber optic connector assembly.

FIG. 13A is a magnified perspective view of a front portion of the holder of FIG. 12 with a multi-fiber ferrule received in a front aperture thereof.

FIG. 13B is a side elevational view of the holder and multi-fiber ferrule of FIG. 13A.

FIG. 13C is a side cross-sectional view of the holder and multi-fiber ferrule of FIGS. 13A-13B.

FIG. 14A is a side elevational view of an induction coil and a portion of the holder of FIG. 12, with the induction coil in a retracted position.

FIG. 14B is a side elevational view of the induction coil and holder portion of FIG. 14A, with the induction coil in a deployed position arranged to cause inductive heating of the holder.

FIG. 14C shows the induction coil and holder portion of FIGS. 14A-14B arranged proximate to a fiber handling apparatus for inserting optical fibers into the ferrule received by the holder.

FIG. 14D shows the induction coil, holder portion, and fiber handling apparatus of FIG. 14C, following retraction of a fiber-loaded ferrule from the holder.

FIGS. 15A and 15B provide bottom perspective and top perspective views, respectively, of multiple optical fibers retained in a multi-fiber ferrule with thermoplastic adhesive material, prior to trimming and polishing of optical fiber ends.

FIG. 16 is a perspective view of a second holder configured to receive a multi-fiber ferrule, in combination with an inductive heating coil and a gas duct, to permit application of a thermal gradient between a rear end face and a front end face of the ferrule as part of a method of fabricating a fiber optic connector assembly.

FIG. 17 is a top plan view of an array of optical fibers including stripped portions and unstripped portions, with a thermoplastic adhesive material pre-applied over a region of the stripped portions in preparation of insertion of the stripped portions into a multi-fiber ferrule.

FIG. 18 is a differential scanning colorimetry plot of heat flow versus temperature for first and second heating cycles of two multi-fiber ferrules, namely, a TMT ferrule and a MT ferrule.

### DETAILED DESCRIPTION

Various embodiments will be further clarified by examples in the description below. In general, the description relates to a fiber optic connector assembly and related fabrication methods that utilize thermoplastic adhesive material arranged between stripped regions of optical fibers and micro-passages of a ferrule body, with the thermoplastic material configured to retain a plurality of optical fibers within the ferrule body. In certain implementations, the thermoplastic adhesive material has a Young's Modulus value of at least 100 MPa, a yield stress of at least 5 MPa, and a Shore A hardness of at least 80 at 25° C. In certain implementations, the ferrule body comprises a different degree of crystallinity at a first (e.g., front) end face than at an opposing second (e.g., rear) end face. In certain implementations, micro-passages defined in a ferrule body are arranged in an array, with outermost micro-passages of the array being spaced apart by a first distance at the front end face, and being spaced apart by a smaller second distance at the rear end face.

Before discussing novel fiber optic connector assemblies and fabrication methods, an introduction to two types of fiber optic connectors configured to retain multiple optical fibers will be provided to facilitate discussion. However, persons skilled in the field of optical connectivity will appreciate that the specific connector types disclosed here are merely examples, and that the general principles disclosed with respect to the multi-fiber ferrules and other components shown in subsequent figures may also be applicable to other connector designs.

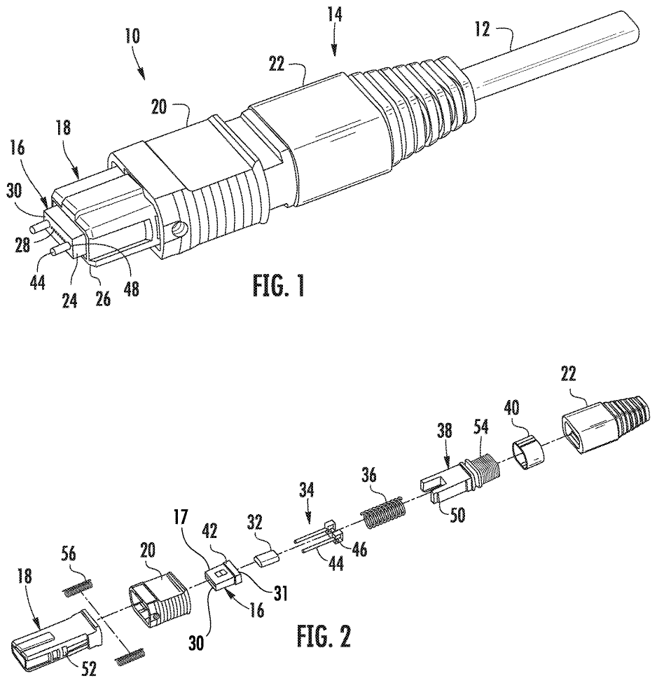

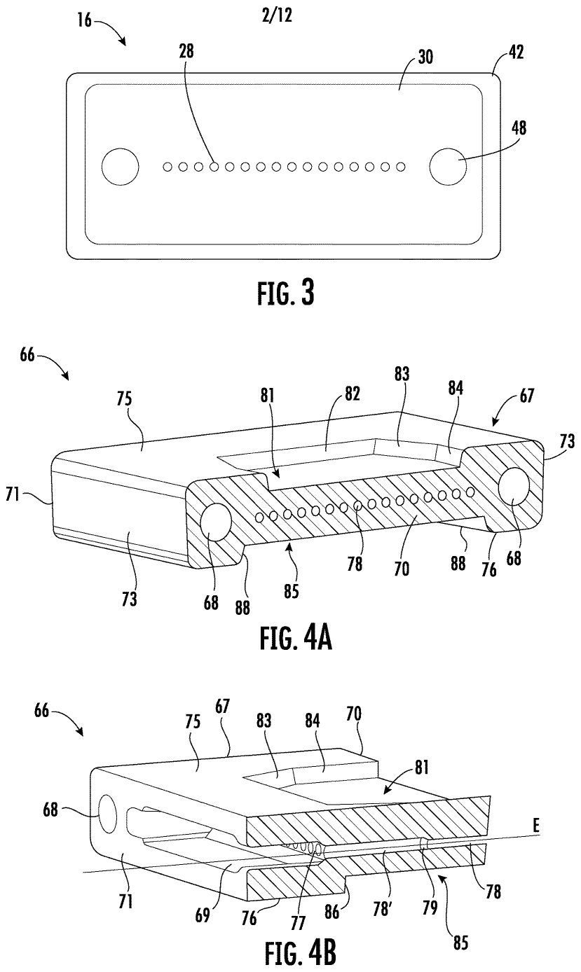

A first example of a fiber optic connector 10 (also referred to as “optical connector 10”, or simply “connector 10”) is shown in FIG. 1, with an exploded view of the connector being provided in FIG. 2, and with a magnified front view of a ferrule 16 of the connector being provided in FIG. 3. The connector 10 is shown in the form of an MTP® connector, which is particular type of MPO connector (MTP® is a trademark of US Conec Ltd.). As shown in FIG. 1, the connector 10 may be installed on a fiber optic cable 12 (“cable”) to form a fiber optic cable assembly 14. The connector 10 includes a ferrule 16, a housing 18 received over the ferrule 16, a slider 20 received over the housing 18, and a boot 22 received over the cable 12. The ferrule 16 includes a body 17 and is spring-biased within the housing 18 so that a front portion 24 of the ferrule 16 extends beyond a front end 26 of the housing 18. Optical fibers (not shown) carried by the cable 12 extend through micro-passages (also known as micro-holes or micro-bores or simply bores) 28 defined in the ferrule 16 before terminating at or near a front end face 30 of the ferrule 16. The optical fibers are secured within micro-passages (28 in FIG. 3) of the ferrule 16 using an adhesive material (e.g., epoxy according to the prior art, or thermoplastic adhesive as disclosed herein) and can be presented for optical coupling with optical fibers of a mating component (e.g., another fiber optic connector; not shown) when the housing 18 is inserted into an adapter, receptacle, or the like.

As shown in FIG. 2, the connector 10 also includes a ferrule boot 32, guide pin assembly 34, spring 36, crimp body 38, and crimp ring 40. The ferrule boot 32, which is unitary in character, is received in a rear portion 42 of the ferrule 16 to help support the optical fibers extending to the micro-passages 28 (shown in FIG. 1). In particular, optical fibers extend through an aperture (not shown) defined through the ferrule boot 32. The guide pin assembly 34 includes a pair of guide pins 44 extending from a pin keeper 46. Features on the pin keeper 46 cooperate with features on the guide pins 44 to retain portions of the guide pins 44 within the pin keeper 46. When the connector 10 is assembled, the pin keeper 46 is positioned against a back surface of the ferrule 16, and the guide pins 44 extend through pin holes 48 (shown in FIG. 1) provided in the ferrule 16 so as to project beyond the front end face 30 of the ferrule 16.

Both the ferrule 16 and guide pin assembly 34 are biased to a forward position relative to the housing 18 by the spring 36. More specifically, the spring 36 is positioned between the pin keeper 46 and a portion of the crimp body 38. The crimp body 38 is inserted into the housing 18 when the connector 10 is assembled and includes latching arms 50 that engage recesses 52 in the housing 18. The spring 36 is compressed by this point and exerts a biasing force on the ferrule 16 via the pin keeper 46. The rear portion 42 of the ferrule 16 defines a flange that interacts with a shoulder or stop formed within the housing 18 to retain the rear portion 42 of the ferrule 16 within the housing 18. The rear portion 42 of the ferrule 16 also includes a recess (not shown) configured to receive at least a front portion of the ferrule boot 32.

In a manner not shown in the figures, aramid yarn or other strength members from the cable 12 are positioned over an end portion 54 of the crimp body 38 that projects rearwardly from the housing 18. The aramid yarn is secured to the end portion 54 by the crimp ring 40, which is slid over the end portion 54 and deformed after positioning the aramid yarn. The boot 22 covers this region, as shown in FIG. 1, and provides strain relief for optical fibers emanating from the fiber optic cable 12 by limiting the extent to which the connector 10 can bend relative to the fiber optic cable 12.

FIG. 3 is a front elevational view of the ferrule 16, showing a one-dimensional array of micro-passages 28 extending to a front end face 41 thereof. As shown, the front end face 41 has a reduced height and width compared to a rear portion 42 thereof. The ferrule 16 may comprise a polymer material, optionally reinforced with inorganic fillers such as glass fibers or beads. In certain embodiments, the ferrule body comprises at least 50 wt % (or at least 60, 70, or 80 wt %) glass filler material, and the polymer of the ferrule body comprises a polymer such as polyphenylene sulfide. Although only a single linear array of micro-passages 28 is shown in FIG. 3, it is to be appreciated that multi-fiber connectors may include multiple rows of micro-passages in certain embodiments.

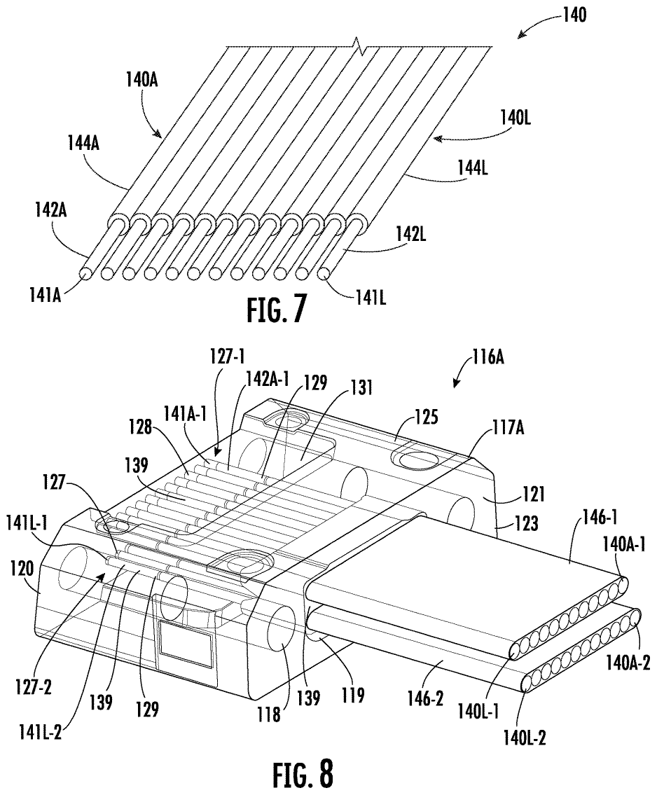

Another exemplary multi-fiber (i.e., a first TMT-type) ferrule 66 including a one-dimensional array of micro-passages 78 is shown in FIGS. 4A and 4B, wherein FIG. 4A is a front perspective view and FIG. 4B is a perspective cross-sectional view of the ferrule 66. The ferrule 66 includes a ferrule body 67 having a front end face 70, a rear end face 71, lateral surfaces 73, a top surface 75 and a bottom surface 76. An upper recess 81 is defined in the top surface 75 and extends to the front end face 70. Edges of the upper recess 81 are bounded by a first forward-facing surface 82, by two first slanted surfaces 83, and by two first lateral surfaces 84. A lower recess 85, which is wider than the upper recess 81, is defined in the bottom surface 76 and also extends to the front end face 70, wherein edges of the lower recess 85 are bounded by a second forward-facing surface 86, by two second slanted surfaces (not shown), and by two second lateral surfaces 88. Pin holes 68 suitable for receiving alignment pins (not shown) extend from the front end face 70 to the rear end face 71 parallel to the lateral surfaces 73. A rear central recess 69 extends from the rear end face 71 into the ferrule body 67, and may have sufficient width and height to receive unstripped portions of multiple optical fibers (not shown). Micro-passages 78 extend along plane E from a medial surface 77 bounding part of the rear central recess 120 to the front end face 70, with the medial surface 77 being intermediately arranged between the front end face 70 and the rear end face 71. The micro-passages 78 include expanded portions 78′ proximate to the medial surface 77 and include chamfered transitions 79 (arranged between the medial surface 77 and the front end face 70) to assist with insertion of stripped portions of optical fibers (not shown) through the rear central recess 69 toward the front end face 70. In various embodiments disclosed herein, thermoplastic adhesive material (not shown) may be provided between the micro-passages 78 and optical fibers (e.g., as shown in FIGS. 7-8) contained therein, wherein thermoplastic adhesive material may also be provided within the rear central recess 120.

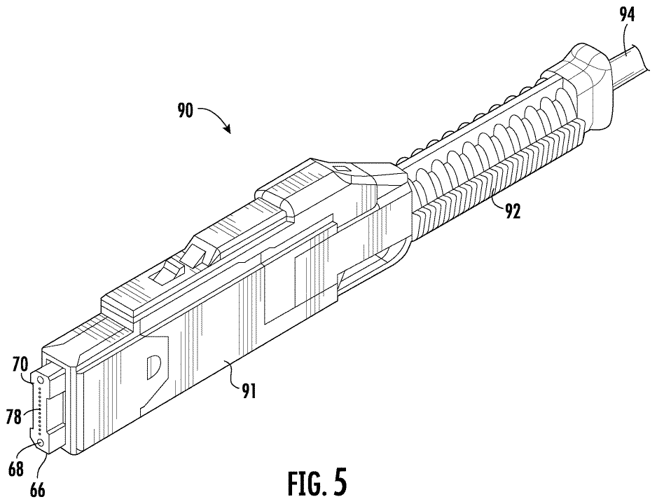

FIG. 5 is a perspective view of a fiber optic connector assembly 90 including a TMT-type multi-fiber ferrule 66 (according to FIGS. 4A and 4B) having micro-passages 78 and pin holes 78 extending to a front end face 70, with the ferrule 66 received by a housing 91 having an associated boot 92, and with a fiber optic cable 94 extending rearward from the boot 92.

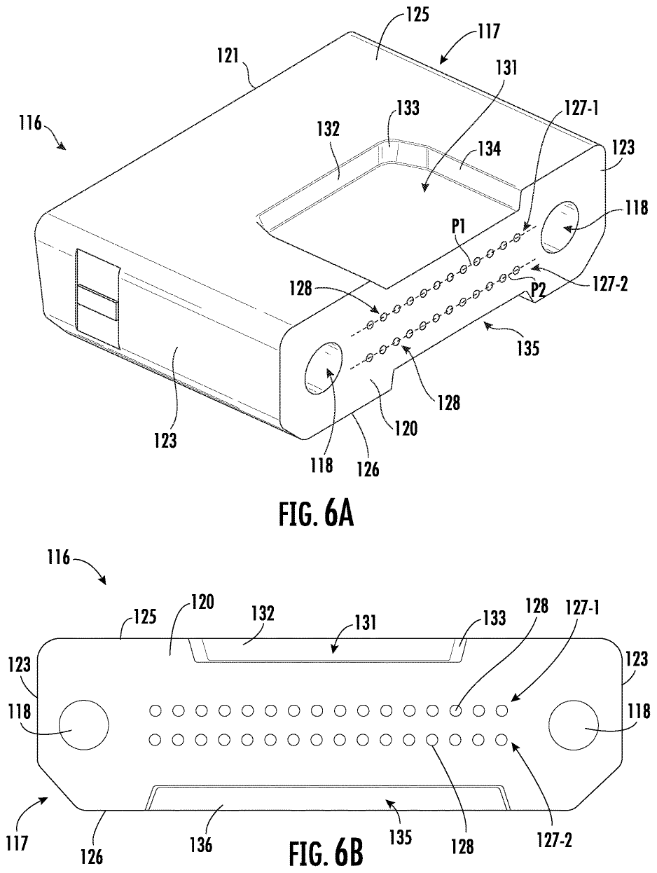

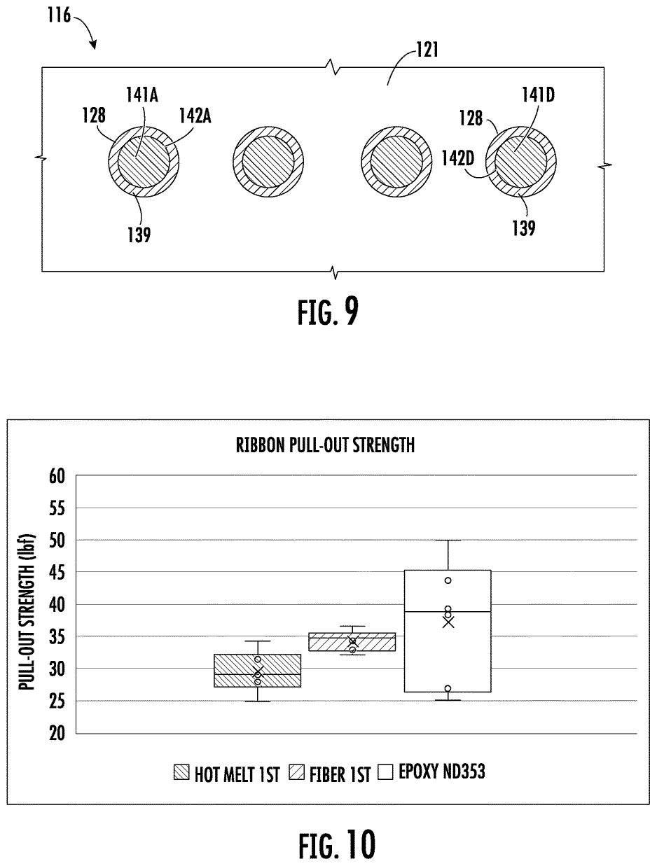

Another TMT-type multi-fiber ferrule 116 having first and second linear arrays 127-1, 127-2 of micro-passages 128 is shown in FIGS. 6A-6B, wherein FIG. 6A is a perspective view and FIG. 6B is a front elevational view of the ferrule 116. The ferrule 116 includes a ferrule body 117 having a front end face 120, a rear end face 121, lateral surfaces 123, a top surface 125, and a bottom surface 126. An upper recess 131 is defined in the top surface 125 and extends to the front end face 120. Edges of the upper recess 131 are bounded by a first forward-facing surface 132, by two first slanted surfaces 133, and by two first lateral surfaces 134. A lower recess 135, which is wider than the upper recess 131, is defined in the bottom surface 126, is bounded in part by a second forward-facing surface 136, and also extends to the front end face 120. The first linear array 127-1 of micro-passages 128 is arranged along a first plane P1, and the second linear array 127-2 of micro-passages 128 is arranged along a second plane P1 that is parallel to the first plane P1, wherein all of the micro-passages 128 extend from the front end fact to a rear central recess (e.g., 119 shown in FIG. 8, and resembling rear central recess 69 shown in FIG. 4B) defined in the rear end face 121. In various embodiments disclosed herein, thermoplastic adhesive material (139 shown in FIGS. 8 and 9) may be provided between the micro-passages 128 and optical fibers (e.g., 140A-140L as shown in FIGS. 7-8) contained therein, wherein thermoplastic adhesive material may also be provided within the rear central recess. Pin holes 118 suitable for receiving alignment pins (not shown) extend from the front end face 120 to the rear end face 121 parallel to the lateral surfaces 123.

FIG. 7 is a perspective view of a one-dimensional array of twelve optical fibers 140 including unstripped portions 140A-140L and stripped portions 142A-142L thereof, with the stripped portions 142A-142L of the optical fibers 140 having fiber ends 141A-141L. Although twelve optical fibers 140 are shown, it is to be appreciated that any suitable number of optical fibers may be provided in a one-dimensional or two-dimensional array.

Having introduced various ferrules for multi-fiber optical connectors, utilization of thermoplastic adhesive material for fixing (bonding) optical fibers to in a multi-fiber ferrule will now be described.

FIG. 8 is a rear perspective, partially transparent view of a TMT-type multi-fiber ferrule 116A having first and second arrays of optical fibers terminated therein, with such arrays of optical fibers emanating from first and second ribbons 146-1, 146-2 extending from a rear central recess 119 defined in a rear end face 121 of the ferrule 116A. The ferrule 116A, which is substantially similar to the ferrule 116 shown in FIGS. 6A-6B, includes a ferrule body 117A having a front end face 120, a rear end face 121, lateral surfaces 123, a top surface 125 (defining an upper recess 131), and a bottom surface 126. Pin holes 118 suitable for receiving alignment pins (not shown) extend from the front end face 120 to the rear end face 121. First and second linear arrays 127-1, 127-2 of micro-passages 128 (each having a chamfered transition 129) extend between the front end face 120 and the rear central recess 119. The first ribbon 146-1 includes unstripped portions 140A-1 to 140L-1 that lead to stripped portions (e.g., 142A-1 as shown) extending through micro-passages 128 of the first array 127-1 of micro-passages 128. Similarly, the second ribbon 146-2 includes unstripped portions 140A-2 to 140L-2 that lead to stripped portions (e.g., 142L-2 as shown) extending through micro-passages 128 of the second array 127-2 of micro-passages 128. Thermoplastic adhesive material 139 is arranged in each of the micro-passages 128 to join optical fibers (e.g., stripped portions of optical fibers emanating from the ribbons 146-1, 146-2) to the ferrule body 117A. Preferably, the same thermoplastic adhesive material 139 is provided in the rear central recess 119 to further bond the ribbons 146-1, 146-2 and/or unstripped portions 140A-1 to 140-L, 140A-2 to 140L-2 of the optical fibers to the ferrule body 117A.

When thermoplastic adhesive material is provided between micro-passages of a ferrule and stripped optical fibers arranged therein, the thermoplastic adhesive material may have a substantially annular shape, such as shown in FIG. 9. FIG. 9 is a front elevational view of a portion of a multi-fiber ferrule 116 showing stripped portions 142A to 142D of optical fibers retained within micro-passages 128 defined in a front end face 121 of the ferrule 116 using thermoplastic adhesive material 139, with terminated ends 141A to 141D being visible along the front end face 121. As shown, the thermoplastic adhesive material 139 may have an annular shape to fill a space between outer surfaces of the stripped portions 142A to 142D of optical fibers and the micro-passages 128.

The above-described thermoplastic adhesive material replaces traditional epoxy bonding material for affixing optical fibers to a ferrule. One challenge associated with using thermoplastic adhesive material is that comparatively few adhesive materials other than epoxies are capable of bonding optical fibers to multi-fiber ferrules and reliably passing GR-1435 certification tests. It has been determined that a desirable thermoplastic adhesive material should have, in combination, a Young's Modulus value of at least 100 MPa, a yield stress of at least 5 MPa, and a Shore A hardness of at least 80 at 25° C. Applicant has found that certain thermoplastic adhesive materials may comprise an adhesive polymer that is at least one of a polyamide, a polyurethane, a polyolefin, an ethylene vinyl acetate, a styrene block copolymer, a polyester, a copolyamide, a copolyester material, or mixtures thereof. Such thermoplastic adhesive materials may further contain one or more additives, including (but not limited to) antioxidants, color concentrates, and viscosity modifier, tackifier, and fillers. Selected commercially available thermoplastic adhesive materials considered by the Applicant are identified in Table 1 below, with such adhesives believed to include polyamide/copolyamide or polyester/copolyester as primary constituents.

TABLE 1
Examples of selected thermoplastic hot melt adhesives

| | Soft point | | Young's | Tensile | |
|---|---|---|---|---|---|
| | (° C.) | Viscosity (cp) | Modulus (MPa) | strength (MPa) | Hardness |
| Kraton Uni-Rez ™ 2626 | 170-184 | 2000-3500 (190° C.) | 269 | 9.3 | A98/D45 |
| Kraton Uni-Rez ™ 2620 | 110-110 | 2600-3200 (190° C.) | 206 | 6.9 | A97 |
| Kraton Uni-Rez ™ 2721 | 155-165 | 5000-6500 (190° C.) | 144 | 6.2 | A80 |
| Bostik ® HM 4156LV | 157 | 18000 (215° C.) | | 18.6 | |
| Bostik ® HM 7116 | 137 | 28000 (215° C.) | | 27.4 | |
| Evonik Dynacoll ® 1611 | 130 | 70000 (200° C.) | | 20 | |
| Henkel Technomelt ® | 167-177 | 3500-5000 (210° C.) | 170 | 11 | A95 |
| 2192B | | | | | |

To demonstrate connector performance with thermoplastic adhesive material (also referred to as “hot melt” material), 12-fiber MPO connectors (incorporating MT ferrules) were made using Kraton Uni-Rez™ 2626 as the fiber bonding agent and compared with the same type of MPO connectors using conventional Epo-Tek® 353 ND epoxy as the fiber bonding agent. For one group of MPO connectors fabricated using Kraton Uni-Rez™ 2626 (i.e., “hot melt first”), the thermoplastic adhesive material was preloaded onto the back of a ferrule and melted using a thermoelectric heater prior to fiber insertion. For another group of MPO connectors fabricated using Kraton Uni-Rez™ 2626 (i.e., “fiber first”), the thermoplastic adhesive material was preloaded onto stripped portions of optical fibers, a ferrule was heated, and thermoplastic-coated optical fibers were inserted into the ferrule. For the MPO connectors fabricated using Epo-Tek® 353 ND epoxy, a typical epoxy termination procedure was employed by prefilling the ferrule with uncured epoxy and cured for 20 min at 100° C. after fiber insertion. All of the MPO connectors were polished and measured in the same way for direct comparison. Fiber retention force was tested using a fiber pull tester. Applicant considered an average per-fiber retention force of 2 lbf (i.e., an aggregate force of 24 lbf for 12 fibers) to be a reasonable minimum pull-out strength value for commercial use. As shown in FIG. 10, the aggregate 12-fiber retention force for MPO connectors bonded with hot melt material was between about 25-35 lbf, in a range on-par with epoxy-bonded MPO connectors exhibiting aggregate 12-fiber retention force values of between about 25-50 lbf.

Another challenge associated with using thermoplastic adhesive material to secure optical fibers in a polymer-based, multi-fiber ferrule is maintaining compliance with the IEC 61755-3-31 specification for optical interface end face geometry dimensions over environmental conditions to which the ferrule may be exposed under normal use. In particular, IEC-61755-3-31 requires optical fibers to have a protrusion height relative to the ferrule end face of between 1 μm and 3.5 μm, and to have a certain amount of coplanarity. The latter is expressed in terms of “minus coplanarity” and is effectively the distance between the lowest fiber protrusion in an array and a best-fit plane through all of the fiber protrusions in the array. Environmental conditions to which a ferrule may be exposed include elevated temperatures and humidity for long durations (thermal and humidity aging), as well as temperatures cycling between relatively cool and hot conditions (thermal cycling). GR-1435, for example, includes tests for these and other environmental conditions that a cable assembly with multi-fiber connectors may experience. Possibly due to the increased softness of thermoplastic material at elevated temperatures during thermal aging and/or thermal cycling tests, Applicant has found that maintaining coplanarity according to IEC-61755-3-31 can be especially challenging.

One potential way to address this challenge is to mix a silane coupling agent with thermoplastic material that is used to as the adhesive. The silane coupling agent may increase bonding to the optical fibers and increase stiffness of the thermoplastic adhesive material. A wide variety of coupling agents may be used, including but not limited to organofunctional silanes with one or more epoxy, amino, mercapto, acrylic ester, and/or other organic functional groups for reacting with organic materials. In some embodiments, the silane coupling agent may also comprise one or more alkoxy, hydroxy, and/or other functional groups for reacting with inorganic materials. In some embodiments, there may be between about 0.1 to about 10 parts by weight of the silane coupling agent per 100 parts by weight of the thermoplastic polymer material. In various embodiments, there may be about 0.1, about 0.5, about 1, about 2, about 4, about 6, about 8, or about 10 parts by weight of the silane coupling agent per 100 parts by weight of the thermoplastic polymer material, or a range between any combination of the above mentioned weight ratios.

Another challenge associated with using thermoplastic adhesive material in lieu of traditional epoxy bonding material for affixing optical fibers to a ferrule is that many thermoplastic adhesive materials require high temperatures to reach a flowable condition that would enable such adhesive materials to occupy micro-passages of a ferrule and permit fiber insertion, at temperature values traditionally considered too high for use with polymer-based multi-fiber ferrules. A typical polymer-based ferrule material comprises (thermoplastic) polyphenylene sulfide and inorganic fillers such as glass fibers or beads. Such polymer-based ferrules generally should not be exposed to temperatures significantly higher than 100° C. (e.g., not exceeding 125° C.-150° C. at an absolute limit) to avoid plastic deformation through cold crystallization, which would result in dimensional changes integrity that could inhibit proper fiber alignment during connector mating and therefore degrade optical performance. This is particularly problematic if the polymer material of a polymer-based ferrule comprises a cold crystallization temperature that is lower than a melting point temperature of the thermoplastic adhesive material.

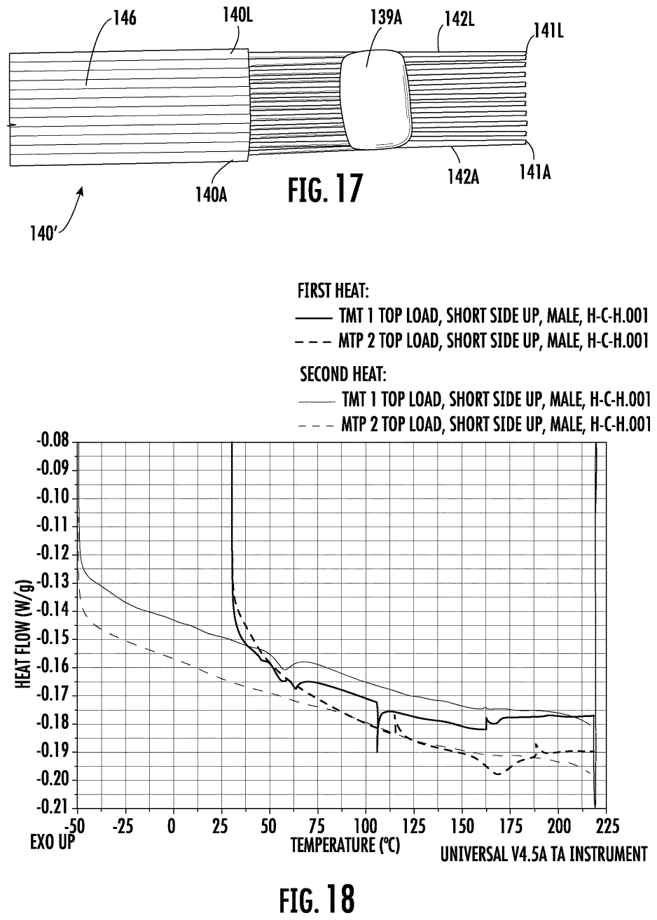

Applicant has observed that when a glass-reinforced polyphenylene sulfide TMT-type ferrule is heated at 180° C. for one minute, the distance between guide pin holes shrinks by approximately 3 to 8 μm, wherein such shrinkage is believed to be due to cold crystallization. This shrinkage phenomenon also causes the distance between micro-passages to be reduced, with the effect being most pronounced when considering distance between the outermost micro-passages closest to the guide pin holes. The phenomenon of cold crystallization appears on differential scanning colorimetry (DSC) scans of glass-filled polyphenylene sulfide ferrules (both MT and TMT type) at temperatures near 150° C.-160° C., as shown in FIG. 18.

Kraton Uni-Rez™ 2626 thermoplastic adhesive material requires a ferrule temperature in excess of 160° C. to melt the adhesive material and allow fibers to be inserted into a ferrule. Such a temperature value leads to a risk of ferrule deformation. Although low temperature thermoplastic adhesive materials are commercially available, other desired properties (e.g., modulus of elasticity, etc.) are compromised, rendering such adhesives insufficient for use in commercial fiber optic connectors.

To permit high temperature thermoplastic adhesive materials to be employed for bonding optical fibers to polymer-based multi-fiber ferrules, various methods disclosed herein include application of a thermal gradient between the front end face and the rear end face of a ferrule, with the front end face (where the plurality of optical fibers are terminated) being subjected to a lower temperature than the rear end face. Such approach is intended to permit utilization of sufficiently high temperatures to soften or melt thermoplastic adhesive material at a rear portion of a ferrule, while causing a front end face (where dimensions are far more critical) to stay well below the cold crystallization temperature and therefore avoid dimensional changes of the front end face that would negatively impact connector performance. A further advantage of providing a cooler front end face is that it may assist in controlling the amount of thermoplastic bonding adhesive that flows out of micro-passages along the front end face, thereby reducing steps that would otherwise be required for adhesive removal and subsequent polishing of fiber ends.

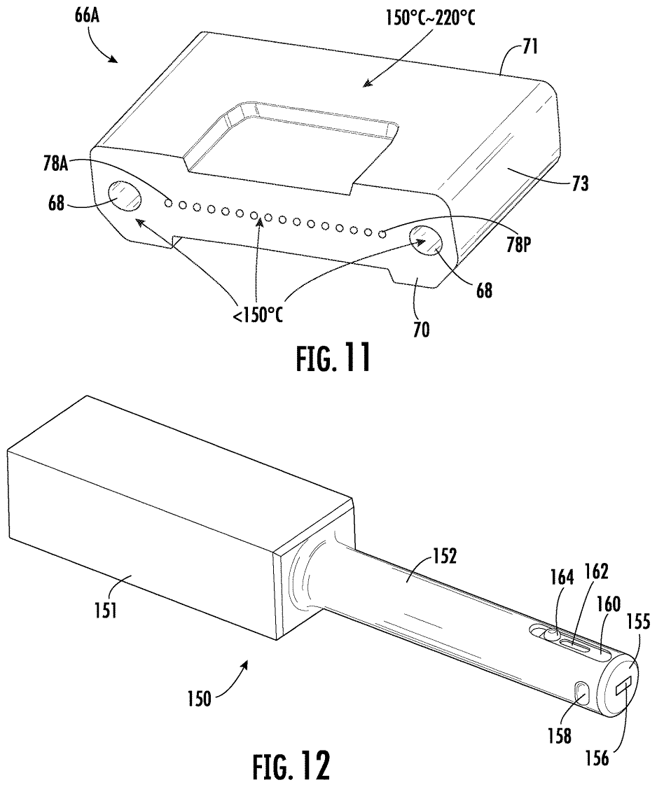

Application of a thermal gradient between opposing faces of a multi-fiber ferrule is schematically illustrated in FIG. 11. This figure shows a TMT-type multi-fiber ferrule 66A having a front end face 70 and a rear end face 71 bounded by side surfaces 73, with micro-passages 78A-78P extending to the front end face 70 and arranged in a one-dimensional array. The outermost micro-passages 78A, 78P are arranged closest to two guide pin holes 68 that extend parallel to the side surfaces 73. As shown, a rear portion (including the rear end face 71) of the ferrule 66A is subject to a high temperature condition (e.g., 150° C. to 220° C.), while the front end face 70 is subject to a lower temperature condition (e.g., less than 150° C.), wherein such conditions may be provided while optical fibers and thermoplastic adhesive material (not shown) are supplied to the ferrule 66A (e.g., by insertion in a direction from the rear end face 71 toward the front end face 70). Maintaining the front end face 70 at a lower temperature reduces the risk of cold crystallization and dimensional changes at the front end face 70, but the high temperature conditions experienced at a rear portion of the ferrule 66A may be sufficient to soften and/or melt thermoplastic adhesive material and permit insertion of optical fibers through the micro-passages 78A-78P.

Upon application of a thermal gradient across front to rear portions of a polymer-based multi-fiber ferrule as disclosed herein, the ferrule may be altered in multiple respects. Firstly, if cold crystallization occurs at a rear portion by not at a front portion of the ferrule, then the ferrule body may comprise a different degree of crystallinity at the first end face than at the second end face. Additionally, ferrule dimensions (including spacing between outermost micro-passages of a one-dimensional array) may be altered at a rear end face. In such an instance, if the ferrule includes a plurality of micro-passages arranged in a one-dimensional array, then outermost micro-passages of the one-dimensional array may be spaced apart by a first distance at the front end face and spaced apart by a second distance at the rear end face, with the second distance being smaller than the first distance. Use of a thermal gradient to maintain lower temperatures at the front end face preserves dimensional integrity at this critical connector surface, while permitting sufficiently high temperatures to be employed to permit thermoplastic adhesive materials to bond optical fibers to a polymer-based multi-fiber ferrule.

Various methods can be employed to establish a thermal gradient across a multi-fiber ferrule. In certain embodiments, a ferrule may be received by a fixture to cause a rear portion of the ferrule to be in conductive contact with the fixture, with a front portion (including the front end face) of the ferrule being free of contact with surfaces of the fixture. For example, a front portion of a ferrule may protrude into air (or another cooling medium, optionally supplied in a forced manner as a gas (or liquid) jet or stream) while a rear portion of the ferrule is arranged in conductive contact with the fixture. Various types of heating may also be employed, such as thermoelectric heating, inductive heating, laser heating, and/or resistance heating; however, inductive heating has been found to be particularly advantageous due to its rapid and highly controllable character. In certain embodiments, a ferrule may be received in a holder (with a front portion of the ferrule being free of conductive contact with any portion thereof) proximate to an induction coil, wherein relative movement between the holder and the induction coil may be effectuated to heat the holder, and thereby heat a rear portion of the ferrule received by the holder. An exemplary holder material may be steel or another magnetically responsive material suitable for inductive heating.

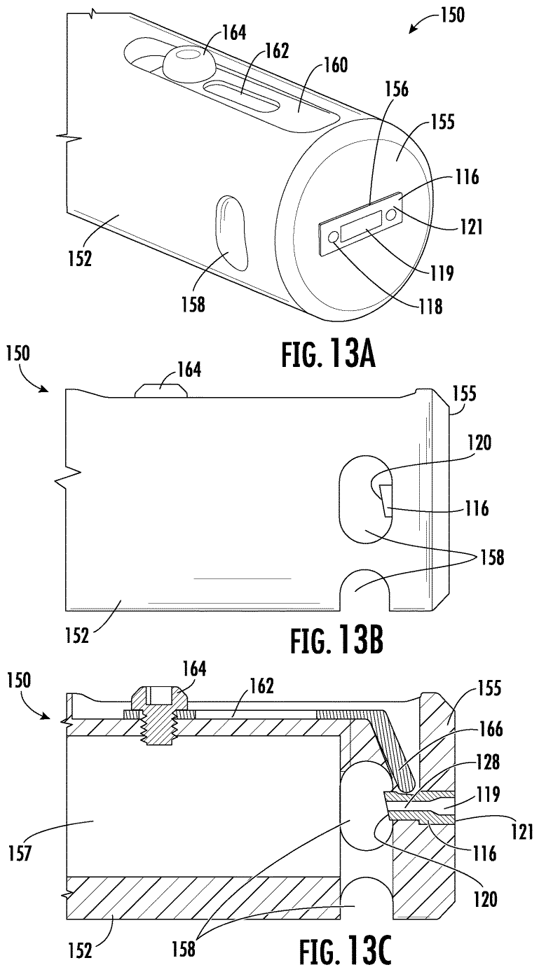

FIG. 12 is a perspective view of a first holder 150 configured to receive a multi-fiber ferrule (not shown) and permit application of a thermal gradient between a rear end face and a front end face of the ferrule. The holder 150 includes a base 151 and a tubular portion 152 terminated at an end 155 defining an aperture 156 for receiving a ferrule (e.g., ferrule 116 in FIG. 13A). The tubular portion 152 may be hollow, and includes a sensor insert 160 having a slot 162 and being joined to the tubular portion 152 with a fastener (e.g., a screw) 164. Lateral openings 158 are defined in the tubular portion 152 proximate to the end 155. Further details regarding the tubular portion 152 of the holder 150 are shown in FIGS. 13A-13C, which provide perspective, side elevational, and cross-sectional views, respectively, of the tubular portion 152 with a rear portion of the ferrule 116 received in the aperture 156 thereof. As shown in FIG. 13A, the ferrule 116 includes a rear end face 121 in which a rear central recess 119 is defined, with guide pin holes 118 extending to the rear end face 121, wherein the rear end face 121 may be substantially flush with the end 155 of the tubular portion 152. As shown in FIGS. 13B and 13C, a front portion of the ferrule 116 including the ferrule front end face 120 is free of conductive contact with the holder 150 and extends into a hollow interior 157 of the tubular portion 151 proximate to the lateral openings 158. FIG. 13C further shows a temperature sensor 166 arranged in contact with a top surface of the ferrule 116, to monitor temperature of the ferrule 116 during a heating process. In certain embodiments, a cooling medium such as air or another fluid may be supplied through hollow interior 157 and the lateral openings 158 to cool a front portion of the ferrule 116 while the tubular portion 152 is being inductively heated (with such heating causing conductive heating of a rear portion of the ferrule 116).

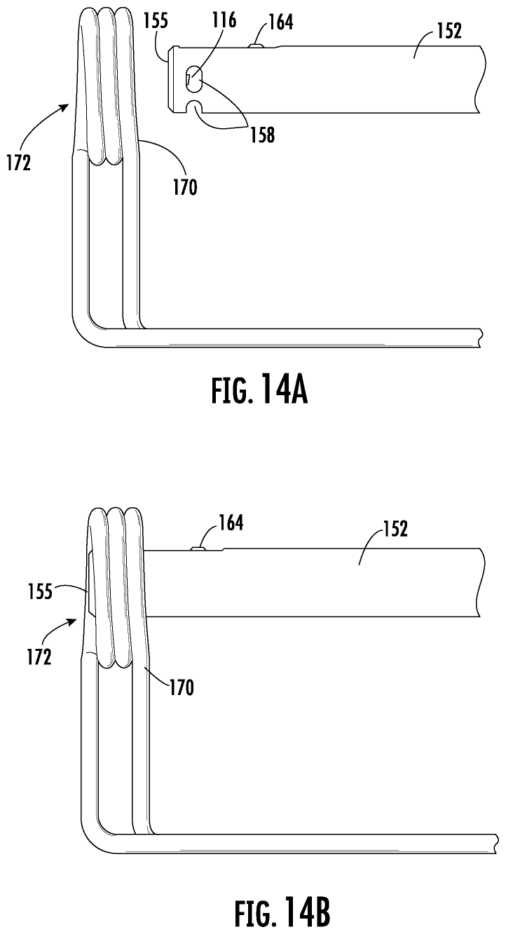

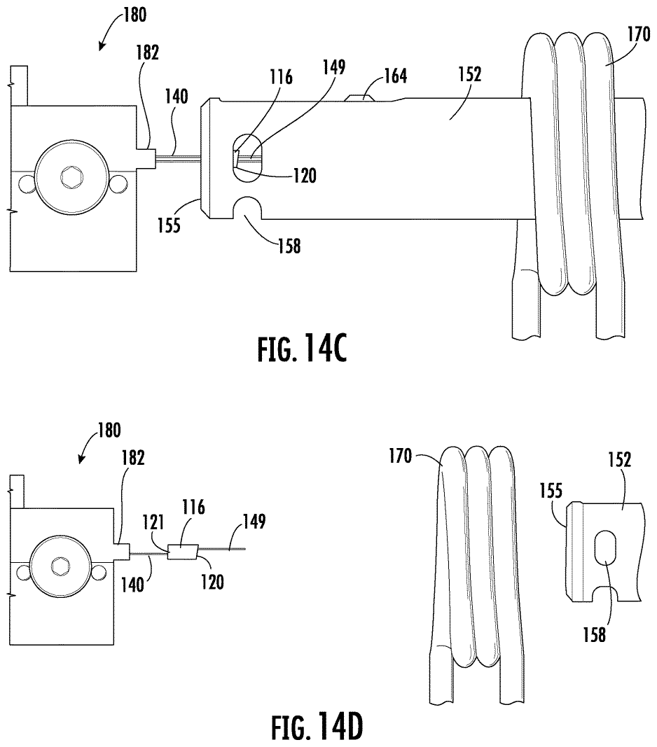

FIGS. 14A-14B are side elevational views showing the tubular portion 152 of the holder 150 (of FIGS. 12 and 13A-13C) in two positions relative to an induction heating coil 170, with the ferrule 116 received by the end 155 of the holder 150. The induction heading coil 170 includes a central opening 172 that is sized to fit around an exterior of part of the tubular portion 152. FIG. 14A shows the induction coil 170 in a retracted position relative to the tubular portion 152, and thereby not capable of inductively heating the tubular portion 152. FIG. 14B shows the induction coil 170 in a deployed position, with the end 155 of the tubular portion 152 arranged in the central opening 172, such that activation of the induction coil 170 may heat the tubular portion 152, thereby causing conductive heating of a rear portion of the ferrule 116. Operation of the induction coil 170 and an optional supply of cooling medium (through the hollow interior 157) may be controlled responsive to signals received from the temperature sensor 166 shown in FIG. 13C.

FIG. 14C shows the induction coil 170 and holder tubular portion 152 of FIGS. 14A-14B arranged proximate to a fiber handling apparatus 180 for inserting optical fibers 140 into the ferrule 116 received by the end 155 of the tubular portion 152. The induction coil 170 is shown in a retracted position, which could occur prior to or after heating of the tubular portion 152 with the ferrule 116 contained therein. In operation, the ferrule 116 is loaded into the end 155 of the tubular portion 152, and the ferrule 116 is provided with optical fibers 140 and thermoplastic adhesive material. In certain embodiments, thermoplastic adhesive material is loaded into the ferrule, the ferrule 116 is heated (indirectly, by positioning and activation of the induction coil 170), and the optical fibers 140 are inserted into and through the ferrule 116. For example, the thermoplastic adhesive material may be initially provided in a monofilament form, and short lengths of the monofilament may be cut and placed into the rear central recess 119 of the ferrule 116, extending transversely (i.e., across a width of the rear central recess 119). Alternatively, the thermoplastic adhesive may be dispensed into the rear central recess 119 by a hot melt glue gun or hot melt jetting device. These and other techniques for loading the thermoplastic adhesive into the ferrule may be done before loading the ferrule 116 into the holder 150 such that the ferrule 116 is pre-loaded with the thermoplastic adhesive, or afterwards.

In certain embodiments, thermoplastic adhesive material is loaded onto the optical fibers (optionally in conjunction with thermoplastic adhesive material supplied to the ferrule 116) prior to inserting the optical fibers 140 into the ferrule 116. For example, the thermoplastic adhesive may be applied to the optical fibers 140 by a hot melt glue gun, a hot melt jetting device, over-molding techniques, or as a laminated film. The application of the thermoplastic adhesive to the optical fibers 140 may occur prior to the termination process for the optical fibers or as a step during the termination process.

Regardless of which technique is used to load, apply, or otherwise provide the thermoplastic adhesive to the rear central recess 119 and/or the optical fibers 140, ultimately the optical fibers 140 are partially inserted into and/or through the ferrule 116, the ferrule 116 is heated (indirectly, by positioning and activation of the induction coil 170), and a remaining length of the optical fibers 140 is inserted into and through the ferrule 116 to cause molten thermoplastic adhesive material to be dragged through micro-passages of the ferrule 116. After cooling of the thermoplastic adhesive material, the ferrule 116 with optical fibers 140 retained therein may be removed from the end 155 of the tubular portion 152 by effectuating relative movement between the tubular portion 152 and the fiber handling apparatus 180 with the optical fibers 140 held by gripping portion 182 of the fiber handling apparatus 180, as shown in FIG. 14D. FIG. 14D thus shows the items of FIG. 14C following retraction of the fiber-loaded ferrule 116 from the tubular portion 152 of the holder (150 in FIGS. 12 and 13A-13C).

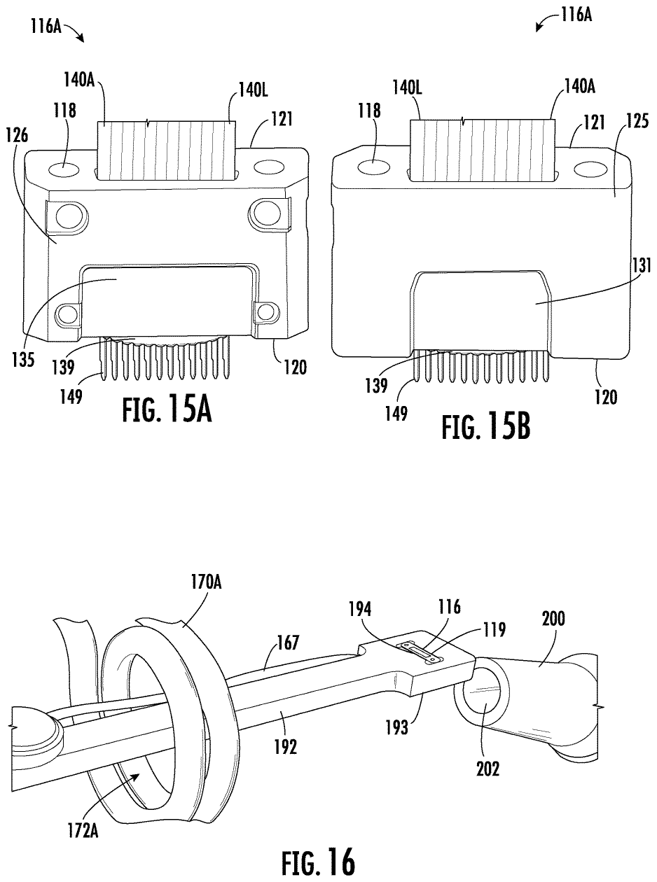

FIGS. 15A and 15B provide bottom perspective and top perspective views, respectively, of multiple optical fibers 140A-140L retained in a multi-fiber ferrule 116A with thermoplastic adhesive material 139, after thermoplastic adhesive material bonding but prior to trimming of adhesive-coated excess fiber portions 149 and polishing of optical fiber ends along the front end face 120. The ferrule 116A is of the same type shown in FIG. 8, with recesses 131, 135 defined in portions of the upper and lower surfaces 125, 126, respectively, that extend between the front and rear end faces 120, 121, and with guide pin holes 118 visible at the rear end face 121.

FIG. 16 is a perspective view of a second holder 192 having a holder end portion 193 configured to receive a multi-fiber ferrule 116, in combination with an inductive heating coil 170A and a cooling duct 200, to permit application of a thermal gradient between a rear end face and a front end face of the ferrule 116. The holder 192 and an associated temperature sensor cable 167 extend through a central opening 172A of the inductive heating coil 170A. The holder end portion 193 includes an opening 194 configured to receive the ferrule 116 with a rear end face thereof facing upward, exposing a rear central recess 119 defined therein. Although not shown, it is to be understood that a front portion including a front end face of the ferrule 116 protrudes downward past the holder end portion 193 to permit the front end face to be cooled by a cooling medium (e.g., air or another fluid) supplied through the cooling duct 200. Such cooling may be performed at the same time that the holder end portion 193 is inductively heated by the inductive heating coil 170A (when positioned around the holder end portion 193) to cause conductive heating of a rear portion of the ferrule 116 contacting the holder 192.

Various methods may be employed to apply a thermoplastic adhesive material, whether to a ferrule and/or to optical fibers, as part of the methods described herein for fabricating a fiber optic connector assembly.

If induction heating is used, then a ferrule may start in a cold state. In certain embodiments, thermoplastic adhesive material may be pre-applied to (e.g., coated on) stripped portions of optical fibers in such a manner to more closely match inner dimensions of ferrule micro-passages, thereby assisting in pre-aligning the optical fibers to the micro-passages before the thermoplastic adhesive is melted. Such pre-application of thermoplastic adhesive material may include, for example, overmolding, film lamination, jetting, or printing.

In certain embodiments, thermoplastic adhesive material may be provided as a monofilament material, wherein segments of monofilament thermoplastic material may be cut and inserted into micro-passages and/or a rear central recess of a ferrule prior to heating.

In certain embodiments, thermoplastic adhesive material may be supplied by a heated gun or jet into desired areas of a ferrule and/or onto optical fibers.

In certain embodiments, thermoplastic adhesive material may be supplied as a custom molded plug (optionally including passages or partial passages for optical fibers) configured to be inserted into a rear central recess of a ferrule.

FIG. 17 is a top plan view of an array of optical fibers 140′ including stripped portions 142A-142L and unstripped portions 140A-140L (which may be arranged in a ribbon 146), with a thermoplastic adhesive material 139A pre-applied over a region of the stripped portions 142A-142L in preparation of insertion of ends 141A-141L the stripped portions 142A-142L into a multi-fiber ferrule (not shown). If the thermoplastic adhesive material 139A is initially in a solid state, then the stripped portions 142A-142L between the thermoplastic adhesive material 139A and the fiber ends 141A-141L may be partially inserted into a ferrule (through micro-holes thereof), followed by ferrule heating to melt the thermoplastic adhesive material 139A, followed by further insertion of the remaining stripped portions 142A-142L into the ferrule, to cause molten thermoplastic adhesive material 139A to be “dragged” by the stripped portions 142A-142L into micro-passages of the ferrule.

FIG. 18 is a differential scanning colorimetry plot of heat flow versus temperature for first and second heating cycles of two multi-fiber ferrules, namely, a TMT ferrule and a MT ferrule comprising glass-filled polyphenylene sulfide. Such plot shows the occurrence of cold crystallization at temperatures near 150° C.-160° C.

Those skilled in the art will appreciate that other modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents. The claims as set forth below are incorporated into and constitute part of this detailed description.

It will also be apparent to those skilled in the art that unless otherwise expressly stated, it is in no way intended that any method in this disclosure be construed as requiring that its steps be performed in a specific order. Accordingly, where a method claim below does not actually recite an order to be followed by its steps or it is not otherwise specifically stated in the claims or descriptions that the steps are to be limited to a specific order, it is no way intended that any particular order be inferred. Moreover, where a method claim herein does not explicitly recite a step mentioned in the description above, it should not be assumed that the step is required by the claim.

What is claimed is:

1. A fiber optic connector assembly comprising:
a ferrule body comprising a polymer material, the ferrule body having a front end face, a rear end face, and a plurality of micro-passages defined in the ferrule body and extending through the front end face;
a plurality of optical fibers extending through the ferrule body and terminated at the front end face, wherein each optical fiber of the plurality of optical fibers comprises a stripped region, and the stripped region of each optical fiber extends through a corresponding micro-passage of the plurality of micro-passages; and
a thermoplastic adhesive material arranged in the plurality of micro-passages between stripped regions of the plurality of optical fibers and the ferrule body, and configured to retain the plurality of optical fibers within the ferrule body, wherein the thermoplastic adhesive material has a Young's Modulus value of at least 100 MPa, a yield stress of at least 5 MPa, and a Shore A hardness of at least 80 at 25° C.

2. The fiber optic connector assembly of claim 1, wherein the ferrule body further comprises glass filler material mixed with the polymer material, wherein the ferrule body comprises at least 50 wt % glass filler material.

3. The fiber optic connector assembly of claim 1, wherein the ferrule body comprises polyphenylene sulfide reinforced with glass filler material.

4. The fiber optic connector assembly of claim 1, wherein:
the ferrule body defines a recess extending through the rear end face and bounded by a medial surface intermediately arranged between the front end face and the rear end face;
the plurality of micro-passages extends from the front end face to the medial surface;
the plurality of optical fibers extends through the recess and through the rear end face; and
the thermoplastic adhesive material is arranged in the recess between the plurality of optical fibers and the ferrule body.

5. The fiber optic connector assembly of claim 4, wherein each optical fiber of the plurality of optical fibers further comprises an unstripped region, and at least a portion of the unstripped region is arranged in the recess of the ferrule.

6. The fiber optic connector assembly of claim 1, wherein the thermoplastic adhesive material comprises an adhesive polymer that is at least one of a polyamide, a polyurethane, a polyolefin, an ethylene vinyl acetate, a styrene block copolymer, a polyester, a copolyamide, or a copolyester material.

7. The fiber optic connector assembly of claim 1, wherein the thermoplastic adhesive material further comprises about 0.1 to about 10 parts by weight of at least one silane coupling agent per 100 parts by weight of the adhesive polymer.

8. The fiber optic connector assembly of claim 1, wherein the polymer material comprises a cold crystallization temperature that is lower than a melting point temperature of the thermoplastic adhesive material.

9. A fiber optic connector assembly comprising:
a ferrule body comprising a polymer material, the ferrule body having a front end face, a rear end face, and a plurality of micro-passages defined in the ferrule body and extending through the front end face;
a plurality of optical fibers extending through the ferrule body and terminated at the front end face, wherein each optical fiber of the plurality of optical fibers comprises a stripped region, and the stripped region of each optical fiber extends through a corresponding micro-passage of the plurality of micro-passages; and
a thermoplastic adhesive material arranged in the plurality of micro-passages between stripped regions of the plurality of optical fibers and the ferrule body, and configured to retain the plurality of optical fibers within the ferrule body;
wherein the ferrule body comprises at least one of the following features (i) and (ii):
(i) the ferrule body comprises a different degree of crystallinity at the first end face than at the second end face; and
(ii) at least some micro-passages of the plurality of micro-passages are arranged in a one-dimensional array, with outermost micro-passages of the one-dimensional array being spaced apart by a first distance at the front end face and spaced apart by a second distance at the rear end face, with the second distance being smaller than the first distance.

10. The fiber optic connector assembly of claim 9, wherein the ferrule body further comprises glass filler material mixed with the polymer material, and the ferrule body comprises at least 50 wt % glass filler material.

11. The fiber optic connector assembly of claim 9, wherein the ferrule body comprises polyphenylene sulfide reinforced with glass filler material.

12. The fiber optic connector assembly of claim 9, wherein:
the ferrule body defines a recess extending through the rear end face and bounded by a medial surface intermediately arranged between the front end face and the rear end face;
the plurality of micro-passages extends from the front end face to the medial surface;
the plurality of optical fibers extends through the recess and through the rear end face; and
the thermoplastic adhesive material is arranged in the recess between the plurality of optical fibers and the ferrule body.

13. The fiber optic connector assembly of claim 12, wherein each optical fiber of the plurality of optical fibers further comprises an unstripped region, and at least a portion of the unstripped region is arranged in the recess of the ferrule.

14. The fiber optic connector assembly of claim 9, wherein the thermoplastic adhesive material comprises an adhesive polymer that is at least one of a polyamide, a polyurethane, a polyolefin, an ethylene vinyl acetate, a styrene block copolymer, a polyester, a copolyamide, or a copolyester material.

15. The fiber optic connector assembly of claim 14, wherein the thermoplastic adhesive material further comprises about 0.1 to about 10 parts by weight of at least one silane coupling agent per 100 parts by weight of the adhesive polymer.

16. The fiber optic connector assembly of claim 9, wherein the polymer material comprises a cold crystallization temperature that is lower than a melting point temperature of the thermoplastic adhesive material.

17. A method for fabricating a fiber optic connector assembly, the fiber optic connector assembly including a ferrule body that comprises a polymer material and including a plurality of optical fibers each comprising a stripped region, the method comprising:
heating at least a portion of the ferrule body, and providing a thermal gradient between the front end face and the rear end face of the ferrule body, with the front end face at a lower temperature than the rear end face; and
inserting stripped portions of the plurality of optical fibers through a rear end face of the ferrule body into a plurality of micro-passages that are defined in the ferrule body and that extend through a front end face of the ferrule body, to cause the stripped portions of the plurality of optical fibers to extend at least to the front end face;
causing the stripped portions of the plurality of optical fibers to extend through molten thermoplastic adhesive arranged between the stripped portions of the optical fibers and the plurality of micro-passages;
allowing the thermoplastic adhesive to solidify in the plurality of micro-passages between the stripped regions of the optical fibers and the ferrule body.

18. The method of claim 17, wherein the thermoplastic adhesive material has a Young's Modulus value of at least 100 MPa, a yield stress of at least 5 MPa, and a Shore A hardness of at least 80 at 25° C.

19. The method of claim 17, further comprising placing at least a portion of the ferrule body in conductive thermal communication with a heating fixture, and the heating comprises heating the heating fixture and permitting conductive transfer of heat from the heating fixture to the at least a portion of the ferrule body.

20. The method of claim 19, wherein the heating of the heating fixture comprises inductive heating.

21. The method of claim 19, wherein upon placing the at least a portion of the ferrule body in conductive thermal communication with the heating fixture, the front end face of the ferrule body is exposed and not in contact with the heating fixture.

22. The method of claim 21, wherein upon placing the at least a portion of the ferrule body in conductive thermal communication with the heating fixture, a front portion of the ferrule body is free of contact with a body portion of the heating fixture that is arranged in conductive thermal communication with a rear portion of the ferrule body.

23. The method of claim 21, further comprising supplying a cooling medium to the front end face of the ferrule body during and/or after the heating of the at least a portion of the ferrule body.

24. The method of claim 17, wherein the heating of the at least a portion of the ferrule body is performed prior to the inserting of the stripped portions of the plurality of optical fibers.

25. The method of claim 17, further comprising applying the thermoplastic adhesive material to the stripped portions of the plurality of optical fibers prior to the inserting of the stripped portions of the plurality of optical fibers.

26. The method of claim 17, wherein:
the ferrule body defines a recess comprises a recess extending through the rear end face and bounded by a medial surface intermediately arranged between the front end face and the rear end face;
the plurality of micro-passages extends from the front end face to the medial surface; and
the method further comprises supplying the thermoplastic adhesive material to the recess prior to the heating of at least a portion of the ferrule body.

27. The method of claim 26, wherein supplying the thermoplastic adhesive material to the recess of the ferrule body comprises positioning a monofilament of the thermoplastic adhesive in the recess.

28. The method of claim 26, wherein supplying the thermoplastic adhesive material to the recess of the ferrule body comprises dispensing molten thermoplastic adhesive into the recess.

29. The method of claim 28, wherein the molten thermoplastic adhesive is maintained in a melted form until and during the heating at least a portion of the ferrule body occurs.

30. The method of claim 28, wherein further comprising:
allowing the molten thermoplastic adhesive to solidify prior to the heating at least a portion of the ferrule body, wherein the heating causes the thermoplastic adhesive to re-melt into a molten form.
